(19) United States
(12) Patent Application Publication
(10) Pub. No.: US 2026/0263304 A1
(43) Pub. Date: Sep. 10, 2026

(54) ORTHOPEDIC PATIENT POSITIONER APPARATUS, SYSTEM, AND METHOD FOR HIP ARTHROPLASTY

(71) Applicant: INNOVATIVE MEDICAL PRODUCTS, INC., Plainville, CT (US)

(72) Inventor: Tamas KOVACS, Burlington, CT (US)

(73) Assignee: INNOVATIVE MEDICAL PRODUCTS, INC., Plainville, CT (US)

(21) Appl. No.: 19/075,740

(22) Filed: Mar. 10, 2025

(51) Int. Cl. A61G 13/00; A61G 13/10; A61G 13/12

(52) U.S. Cl. CPC A61G 13/0081; A61G 13/101; A61G 13/1225; A61G 13/1285

(57) ABSTRACT

A surgical patient positioner is described wherein a base plate includes a plurality of tracks configured to slidably couple to anterior and posterior support assemblies, useful for lateral decubitus, hip arthroplasty. The base plate is contoured to fit between the pelvis and rib cage of the patient to avoid pressuring skeletal tissue, and includes ratchet recesses coupled with quick release latches. The anterior tower includes domed pad holders that may couple to the iliac crests. The pad holder supports are slidably adjustable vertically and/or horizontally by means of latching push pins and configured for single hand operation. A lower back support plate is slidably coupled to the posterior support tower and is vertically adjustable. The positioner may be secured to the OR table by brackets and extensions coupled to the support plate and clamps coupled to the rails. Radiolucent materials may be used throughout the surgical patient positioner.

### TECHNICAL FIELD

The present invention relates generally to an orthopedic positioner apparatus, system, and method and, in particular, to a radiolucent positioner system for supporting the pelvic skeleton of a patient for a surgical procedure using robotics and imaging during the procedure.

### BACKGROUND

Conventional positioner systems generally provide the support for the patient when undergoing a predetermined surgical procedure such as, for example, hip arthroplasty—more commonly known as a hip replacement surgery. Prosthetic hip joints are routinely used to replace a patient's hip joint when that joint is damaged. Currently many tens of thousands of such hip replacement operations are performed each year around the world, and that number is increasing. For hip arthroplasty (or possibly for repairing a hip fracture), positioner systems may support a patient in a position lying on one side, commonly referred to as a lateral decubitus position.

Conventional lateral decubitus positioner systems are subject to a variety of disadvantages. First, positioners can slip during surgery thereby repositioning the body of the patient, which has adverse effects to the surgical procedure and health of the patient. Threaded fasteners are typically used to hold component parts of the system, and these fasteners have radiopaque interference and are subject to undesired loosening or slipping on account of the physical forces applied to the patient during surgery. Modern hip replacement surgeries can also use imaging and robotic equipment that require a firm immobilization of the patient. In this respect, robotic surgery typically relies on a frame of reference, such as a coordinate system, that needs to be maintained throughout the procedure—so that the robot knows where it “is” in three-dimensional space—and changing the location of the body relative to that coordinate system is generally not desirable when radiopaque interference is introduced by the positioner in the frame of reference.

Furthermore, conventional hip positioners typically comprise complex structural assemblies that obstruct the surgical area to robotic arms and imaging devices such as, for example, bars, plates and extensions that restrict access to the surgical area. Obstruction of the surgical site is undesirable for at least several reasons. For one, positioners get in the way of the surgeon. For another, the positioner typically blocks radiography and imaging techniques that are desired when the patient is in position. Conventional positioner systems may have radio-opacity disadvantages where radiopaque materials with a high radio opacity interfere with imaging systems. Many component parts and base plates of conventional positioner systems are radiopaque from use of, for example, metals and metal alloys. Conventional positioner systems' radiopaque assemblies and systems interfere with imaging particularly when the patient is positioned for surgery, such as a lateral decubitus position. For yet another, the positioner may inhibit range of motion checks where, for example, it may be desirable to flex the hip beyond 90 degrees to check range of motion and stability of the hip joint, among other reasons.

And there exists a problem that competes with size and complexity of the positioner, which is that conventional hip positioners should be versatile to accommodate patients of varying sizes. An obese patient will have different holding characteristics than a non-obese patient, for example. Similarly, a patient with a large pannus—which refers to an overgrowth of tissue, often associated with conditions like rheumatoid arthritis (affecting joints) or in cases of morbid obesity, where it describes excess abdominal skin and fat that hangs over the lower abdomen—will require a patient positioner with the flexibility to accommodate the patient's shape, while achieving the desired stability and holding.

Conventional hip positioner support assemblies may also have numerous parts that are often difficult to clean; even though hip arthroplasty uses positioners that are typically non-sterile, the parts still must be sterilized between surgeries, as well as assembled, disassembled, and stored. And additionally, conventional positioners may cause damage to the patient's tissues by virtue of the holding forces imparted to the body and/or restriction of the circulatory system, and/or other complications attributable to the pressure applied to the body. In one example, the support plate that comes in contact with the support table and the side of the patient that is facing down, when place in the lateral decubitus position, and can cause damage or post-surgical discomfort. Even though the support plate may be covered with padding, over the course of the surgery this may cause significant patient discomfort.

It is therefore desirable, and indeed a long-felt need in the industry exists, to provide an improved apparatus, system, and method of patient positioning that eliminates the aforementioned drawbacks, and other drawbacks, to produce better surgical outcomes.

### SUMMARY

It is an object of the apparatus, system, and method according to the present invention to provide a surgical patient positioner capable of improved holding characteristics, including multiple, discrete adjustments, such as pawl or ratcheting mechanisms, or the like. This disclosure contemplates providing multiple discrete adjustments that reduce or eliminate the likelihood of unintended movement, once the patient is put in the desired position, a benefit over the prior art which is achieved at least in part by pressing a physical actuator, or other positive action, that results in disengagement of an associated pawl or ratcheting mechanism, to thereby result in a movement of the patient. Accordingly, the positioning of the patient is improved.

It is another object of the apparatus, system, and method according to present invention to provide a surgical patient positioner that minimizes obstruction of the surgical area by reduction of parts. Accordingly, the invention provides surgical personnel with improved room to operate, as well as for imaging access and other purposes, such as use of a fluoroscopy C-Arm while the patient is in position. In one aspect, embodiments of the present invention provide a support plate adapted for extended flexion of the hip and other range of motion checks conducted during the surgery.

It is another object of the apparatus, system, and method according to the present invention to provide a surgical patient positioner that is easily and intuitively adjustable, with improved versatility to accommodate patients of varying sizes and positioning requirements. For example, this disclosure contemplates embodiments of the present invention that are well suited to accommodate patients with a large pannus, without compromising on the positioning stability of the device.

It is another object of the apparatus, system, and method according to the present invention to provide a surgical patient positioner that reduces damage to the patient's tissues and reduces post-surgical discomfort.

In one aspect, it is contemplated that the surgical patient positioner 100 may operate effectively as a three-point positioning system: (i) lower back at the rear of the pelvis, (ii) upper iliac crest, and (iii) lower iliac crest. Although other rigid mechanical positioning is concerned falling within the scope of this disclosure, such as coupling to other body parts than those provided directly above.

In another aspect, conventional latching, or holding, mechanisms may loosen over time and/or may not otherwise provide for secure holding. The surgical patient positioner 100 according to the present invention overcomes these disadvantages.

In another aspect, the surgical patient positioner 100 reduces the number of parts, thereby achieving a superior technical advantage over conventional designs.

In another aspect, the surgical patient positioner 100 reduces the number and severity of reentrant surfaces which makes the positioner 100 easier to clean and sterilize in between surgeries, in accordance with cleanliness medical standards.

In another aspect, the surgical patient positioner 100 is easier to set up because it requires no, or virtually no, threaded parts. Similarly, the quick release nature of the rachet and latch systems make takedown quicker than conventional designs.

In another aspect, both the anterior and posterior support systems are locked to the OR table.

In another aspect, solid locking mechanisms are used, instead of knobs, where the latter tend to loosen and the former do not.

In another aspect, all, or substantially all, of the components of the surgical patient positioner are made of plastic such as Delfin, which provides for a lighter system, that gives more space for the doctor to work in, is easier to set up, and is translucent, so that radiography and other imaging can be done in situ. Other materials may be substituted that achieve one or more of the desired objectives stated herein.

Other desirable features and characteristics will become apparent from the subsequent detailed description, the drawings, and the appended claims, when considered in view of this background.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a front, top, left-side perspective view of a surgical patient positioner, according to an embodiment of the present invention;

FIG. 2 illustrates a back, top, left-side perspective view of a surgical patient positioner, according to an embodiment of the present invention;

FIG. 3 illustrates an exploded, front, top, left-side perspective view of a surgical patient positioner, according to an embodiment of the present invention;

FIG. 4 illustrates a front, top, left-side perspective view of a base plate for a surgical patient positioner, according to an embodiment of the present invention;

FIG. 5A illustrates a top view of a base plate for a surgical patient positioner, according to the embodiment of the present invention shown in FIG. 4;

FIG. 5B illustrates a bottom view of a base plate for a surgical patient positioner, according to the embodiment of the present invention shown in FIG. 4;

FIG. 5C illustrates an enlarged front view of the base plate for a surgical patient positioner, according to the embodiment of the present invention shown in FIG. 4;

FIG. 6 illustrates an enlarged, front, top, left-side perspective view of an anterior support assembly for a surgical patient positioner, according to an embodiment of the present invention;

FIG. 7 illustrates an exploded, enlarged, front, top, left-side perspective view of an anterior support assembly for a surgical patient positioner, according to an embodiment of the present invention;

FIGS. 8A & 8B illustrate a cross-sectional view of the fastener assembly taken along the line shown in FIG. 6, according to an embodiment of the present invention, demonstrating the operability thereof;

FIGS. 9A-9C illustrate a cross-sectional view of the fastener assembly taken along the line shown in FIG. 6, according to an embodiment of the present invention, demonstrating the operability thereof;

FIG. 10 illustrates an enlarged, front, top, left-side, perspective view of a posterior support assembly for a surgical patient positioner, according to an embodiment of the present invention;

FIG. 11 illustrates an exploded, enlarged, front, top, left-side perspective view of a posterior support assembly for a surgical patient positioner, according to an embodiment of the present invention;

FIG. 12 is an environmental view of a patient secured to an OR table by a surgical patient positioner, according to an embodiment of the present invention;

FIGS. 13A-13C illustrate a tower base for a surgical patient positioner, according to an alternative embodiment of the present invention;

FIG. 14A illustrates a front, top, left-side, perspective view of a base plate for a surgical patient positioner, according to an alternative embodiment of the present invention;

FIG. 14B illustrates a back, bottom, right-side, perspective view of a base plate for a surgical patient positioner, according to an alternative embodiment of the present invention;

FIG. 14C illustrates a top view of a base plate for a surgical patient positioner, according to an alternative embodiment of the present invention;

FIG. 14D illustrates a bottom view of a base plate for a surgical patient positioner, according to an alternative embodiment of the present invention;

FIG. 14E illustrates a left-side view of a base plate for a surgical patient positioner, the right-side view being a mirror image thereof, according to an alternative embodiment of the present invention;

FIG. 14F illustrates a back view of a base plate for a surgical patient positioner, according to an alternative embodiment of the present invention;

FIG. 14G illustrates a front view of a base plate for a surgical patient positioner, according to an alternative embodiment of the present invention;

FIG. 15A illustrates a back, top, left-side, perspective view of an extension bar for a surgical patient positioner, according to an embodiment of the present invention;

FIG. 15B illustrates a back, bottom, left-side, perspective view of an extension bar for a surgical patient positioner, according to an embodiment of the present invention;

FIG. 15C illustrates a top view of an extension bar for a surgical patient positioner, according to an embodiment of the present invention;

FIG. 15D illustrates a bottom view of an extension bar for a surgical patient positioner, according to an embodiment of the present invention;

FIG. 15E illustrates a left-side view of an extension bar for a surgical patient positioner, according to an embodiment of the present invention;

FIG. 16A illustrates a back, top, left-side, perspective view of an extension bar for a surgical patient positioner, according to an alternative embodiment of the present invention;

FIG. 16B illustrates a back, bottom, left-side, perspective view of an extension bar for a surgical patient positioner, according to an alternative embodiment of the present invention;

FIG. 16C illustrates a top view of an extension bar for a surgical patient positioner, according to an alternative embodiment of the present invention;

FIG. 16D illustrates a back view of an extension bar for a surgical patient positioner, according to an alternative embodiment of the present invention;

FIG. 17A illustrates a perspective view of a bracket for a surgical patient positioner, according to an embodiment of the present invention; and

FIG. 17B illustrates a side view of a bracket for a surgical patient positioner, according to an embodiment of the present invention.

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

For ease of reference, “anterior” as used herein refers to the side of a support table closest to the front side of the patient, i.e., the front of the patient faces that lateral side of the table. And “posterior” as used herein refers to the opposite side as that of the “anterior”.

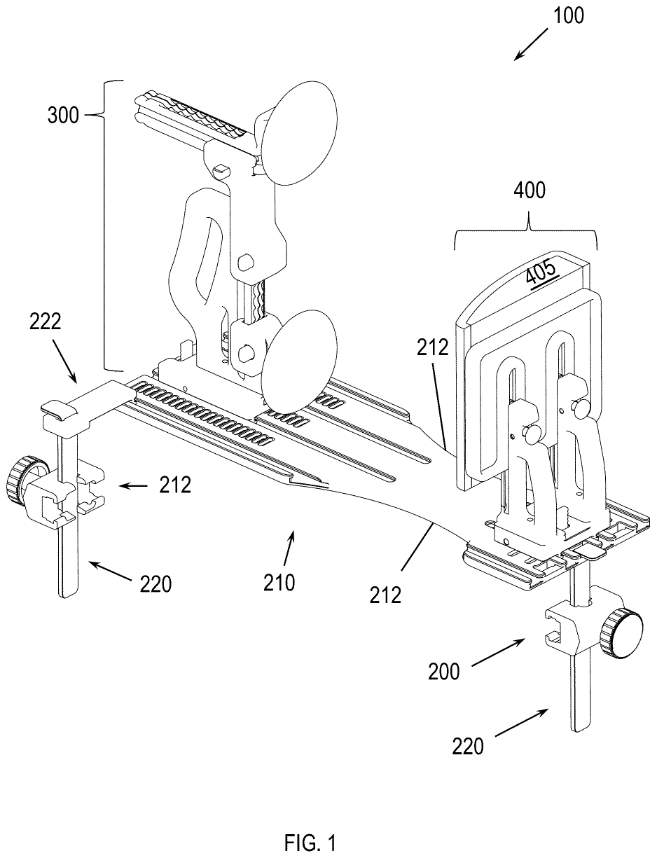

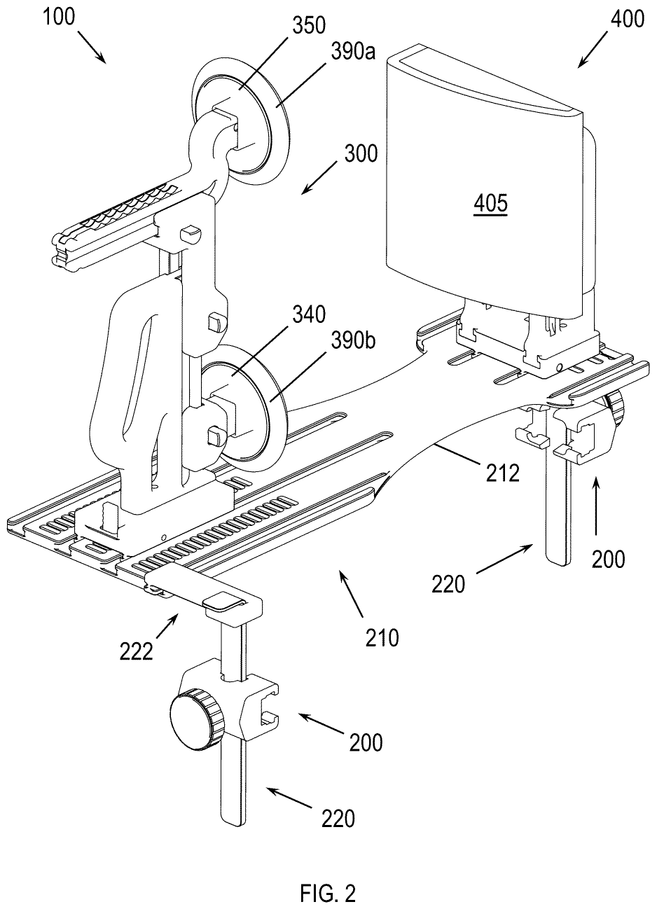

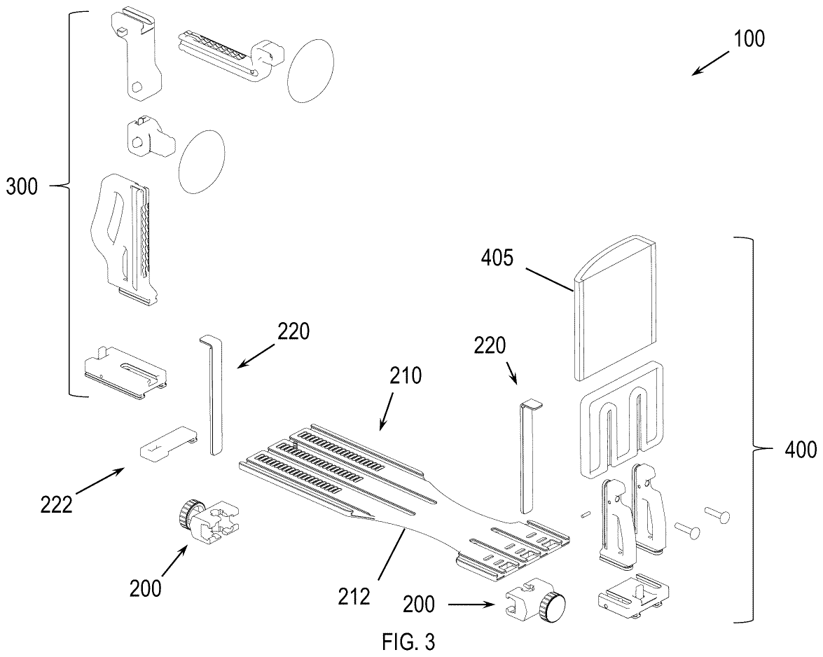

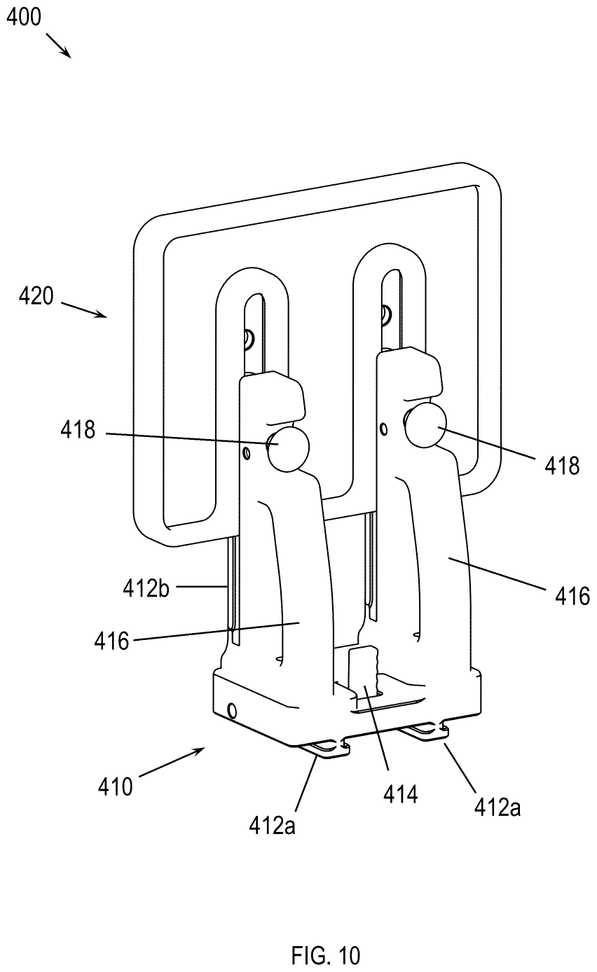

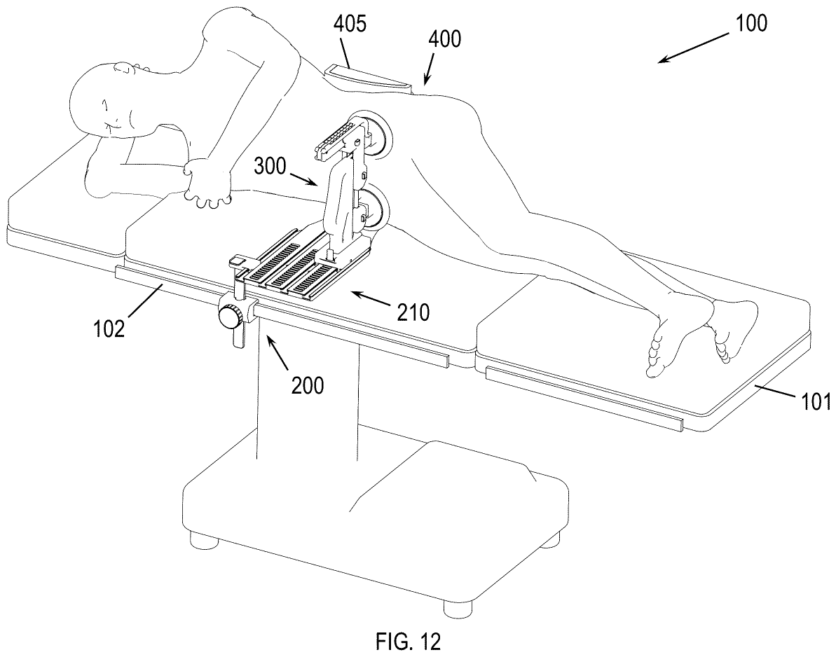

Referring to FIGS. 1-17B, an apparatus, system, and method for securing or otherwise positioning a patient to a support table 101, such as an operating room table 101, is generally shown as element 100; this surgical patient positioner 100 is described as one or more exemplary embodiments of the present invention. The surgical patient positioner 100 may be usefully employed in a variety of applications and fields of technology. For example, as shown in FIG. 12, the positioner 100 may be used to hold a surgical patient in the lateral decubitus position for hip arthroplasty, or total hip arthroplasty. Other applications of the positioner 100 include, but are not limited to, surgery to repair a hip fracture, and the positioner 100 is advantageously suitable for radiography applications where radio-translucence is needed so that imaging is not obstructed. FIGS. 1 and 2 show the surgical patient positioner 100 from different perspectives.

The surgical patient positioner 100 may comprise a base plate 210 which may be coupled to either or both side rails 102 of a support table 101, such as an operating room (OR) table 101. In a preferred embodiment, one or more clamps 200 may couple to each side rail 102, the clamp 200 configured to receive a bracket 220. Clamp 100 can be a rail clamp designed to accept OR table accessories that have a flat or round insertion end such as, for example, manufactured and offered for sale by Innovative Medical Products, Inc. part no. CAT #409. Advantageously, an extension bar 222 may couple the bracket to the base plate 210, or conversely, the extension bar 222 may couple directly to the base plate 210. The patient may be positioned on the base plate 210, preferably as shown in FIG. 12, with the patient disposed, for example, in the lateral decubitus position. On either side of the patient may be disposed support assemblies, such as an anterior support assembly 300 on the anterior side, and a posterior support assembly 400 on the posterior side.

The following description may be considered as describing the method of assembling the positioner 100 in advance of a surgery, and the reverse may describe the disassembling process or method thereof, post-surgery.

Referring to FIGS. 1-3, 12, and 15A-17B, the surgical patient positioner 100 is adapted to couple to the side rails 102 of an OR table 101. One or more clamps 200 may be disposed on either or both side rails 102. A corresponding bracket 220 may be coupled to a respective clamp 200. As shown in FIGS. 17A and 17B, the bracket 220 may include a bracket head 221a, a bracket body 221b, and an incongruity 221c. The incongruity 221c may be including for ease of manufacturing purposes, where the bracket body 221b is sized to accommodate one or more industry rail clamps, and then tapered thinner to more easily bend the bracket head 221a proximate the incongruity in the manner illustrated. The thinner profile of the bracket head 221a has an additional benefit of allowing the anterior support assembly 300 to slide over it, when in an assembled configuration. The bracket head 221a may be coupled to the base plate directly via a bracket opening 218, in the manner shown on the posterior side, the bracket head 221a may couple to an extension bar 222 via a bracket receiver 226 thereof. The bracket 220 may take any shape suited for the intended purpose and is non-limiting in this regard; for example, the bracket head 221a may be T-shaped, and/or at least a part of the cross-section of the bracket 220 may be circular, oval, square, or otherwise. Such as clamped to the OR table 101 rail by a clamp 100.

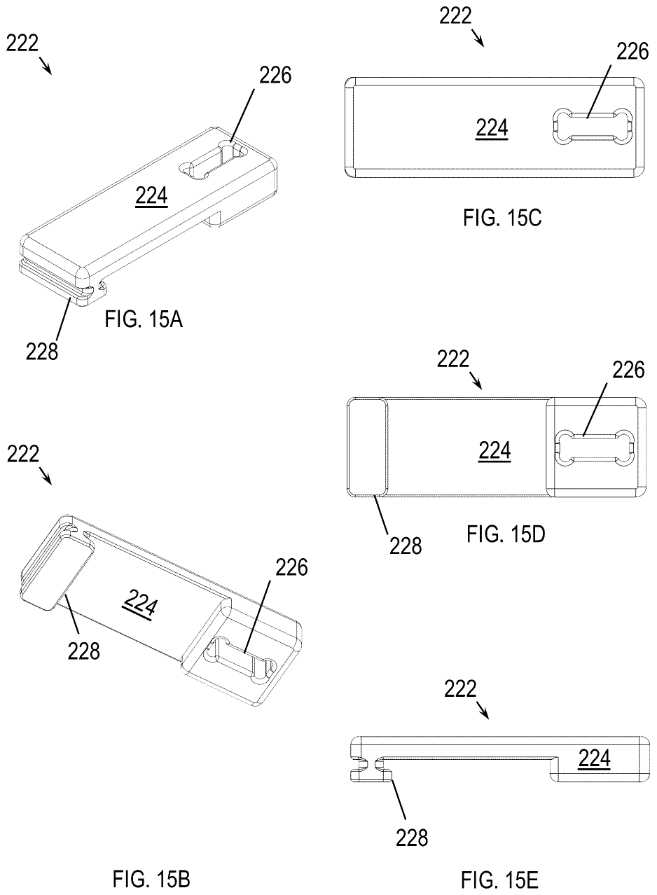

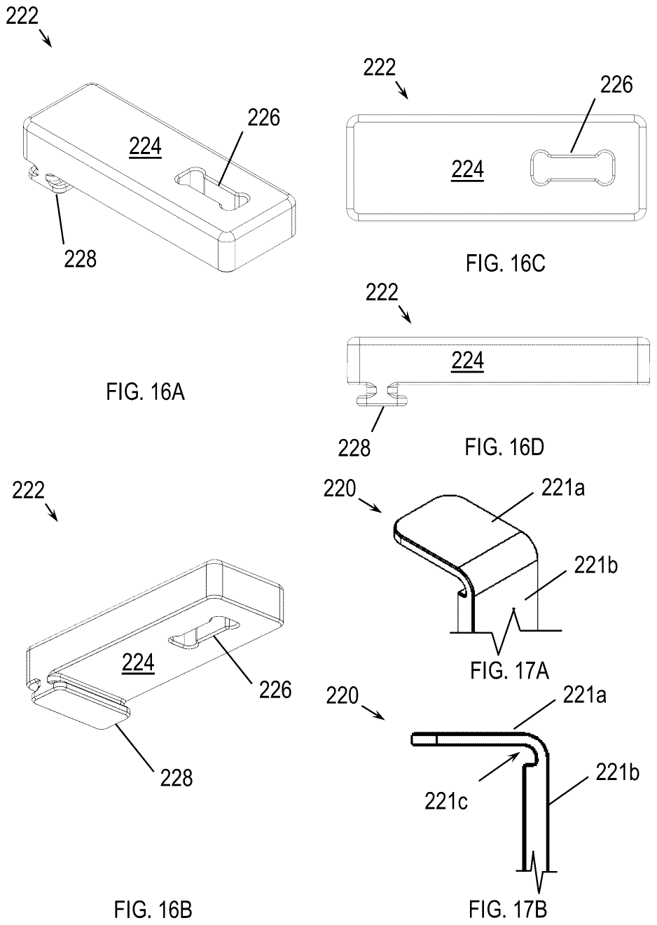

The extension bar 222 is suitable for advantageously offsetting the location of the clamp 200 and associated components to free up the area proximate the base plate 210 that would otherwise be obstructed thereby e.g. allowing the surgeon more space to operate. Referring to FIGS. 15A-16B in particular, the extension bar 222 may include a body 224, a bracket receiver 226 proximate one end of the body 224, and a bracket rail 228 proximate the other end of the body 224. In one embodiment of the base plate 210 and extension bar 222 represented in FIGS. 1-5C and FIGS. 15A-15E respectively, the extension bar 222 may couple to the base plate 210 in the manner illustrated in e.g. FIGS. 1-2 and 12, where the bracket rail 228 is configured to couple to one of the track slots 215 on the anterior side of base plate 210.

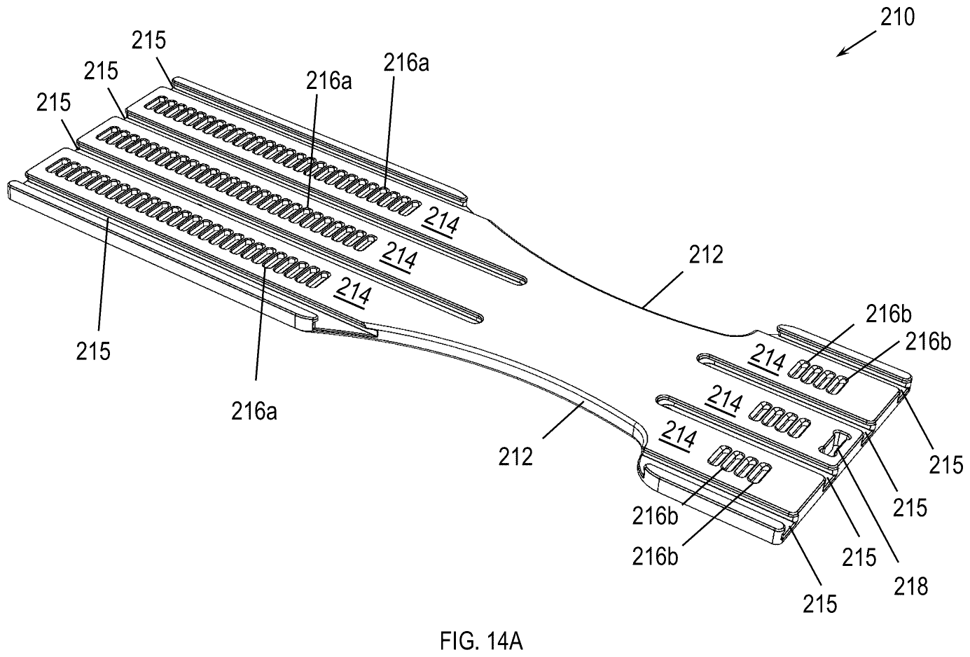

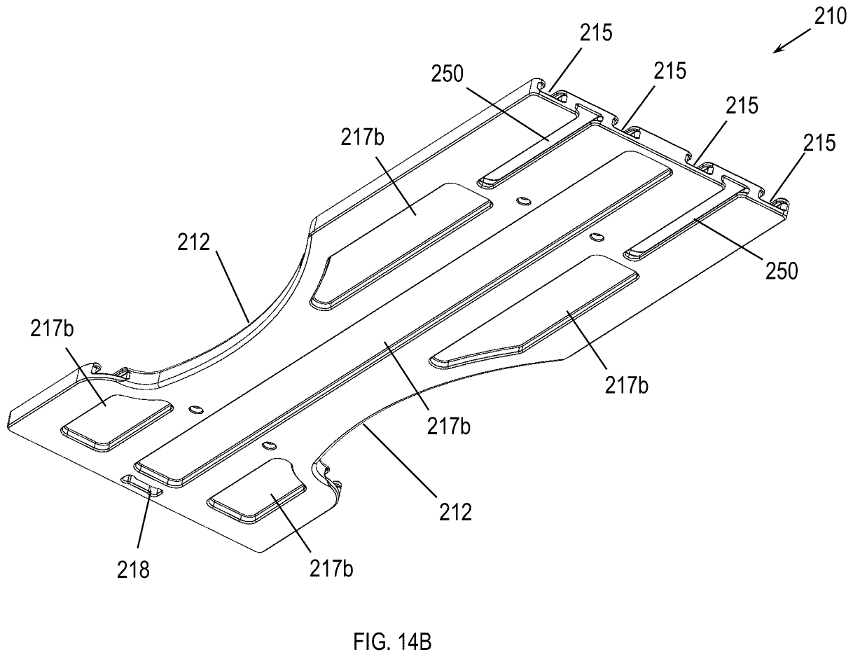

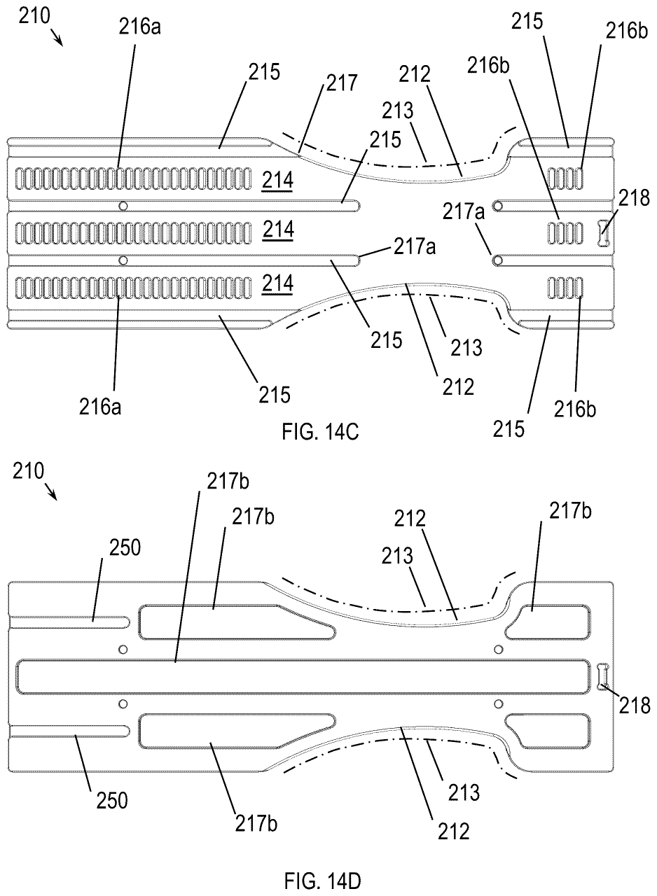

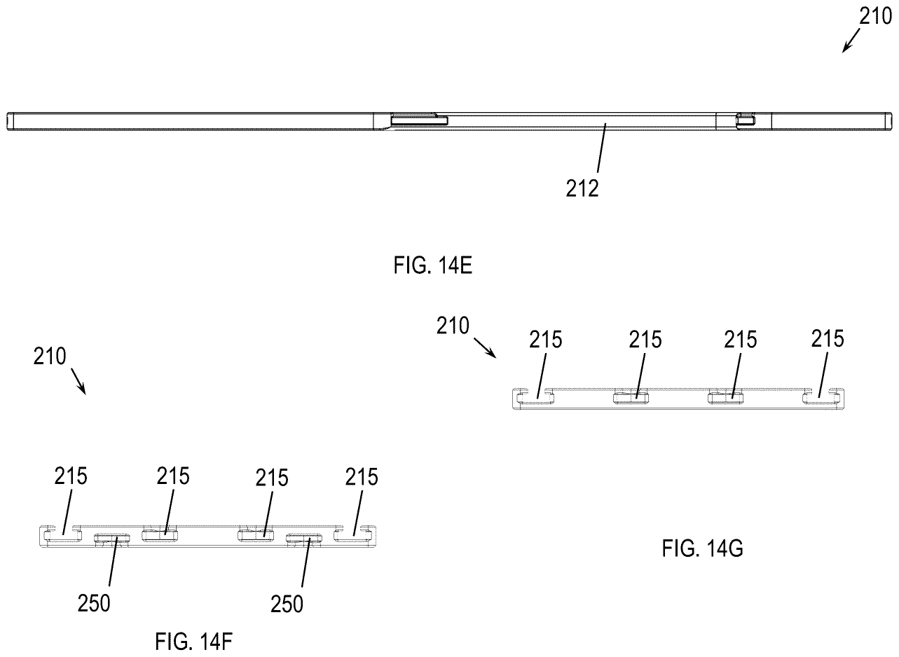

Although not represented in the preferred embodiment, a second clamp 200, bracket receiver 226 and extension bar 222 may be coupled on the anterior side (not shown) of the OR table 101, further along the side rail 102 and on the opposite side of the base plate 210's anterior side, for additional stability of the positioner 100. In an alternative embodiment of the base plate 210 and an alternative embodiment of the extension bar 222 represented in FIGS. 14A-14F and FIGS. 16A-16D respectively, the components may be coupled in a different manner. In the alternative embodiments thereof, the extension bar 222 couples to the underside of the base plate 210, where the rail 228 of the extension bar 222 couples to the extension bar slot 250 of the base plate 210, as shown in FIG. 14D.

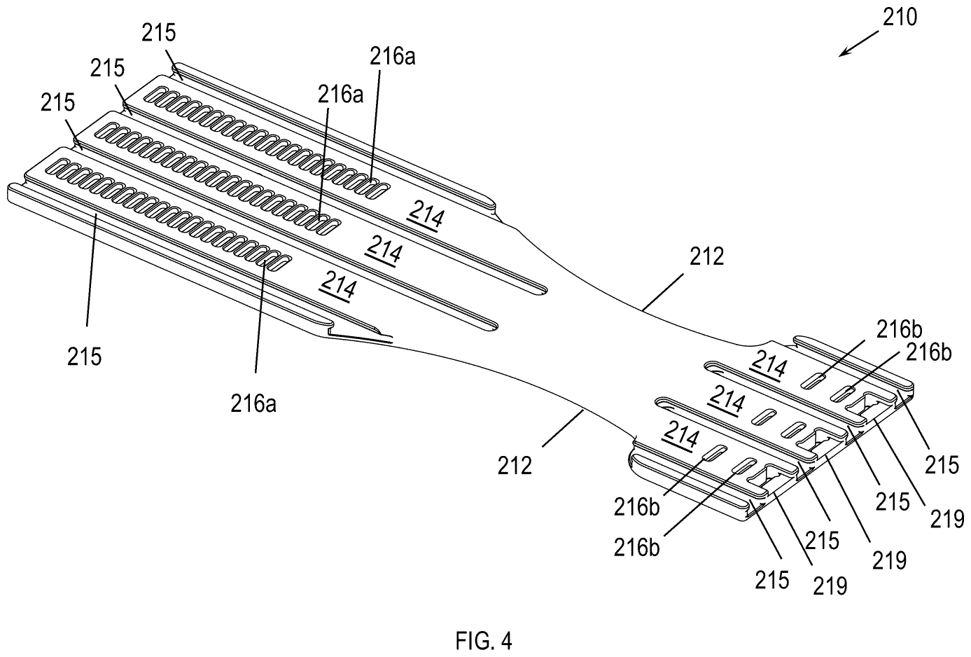

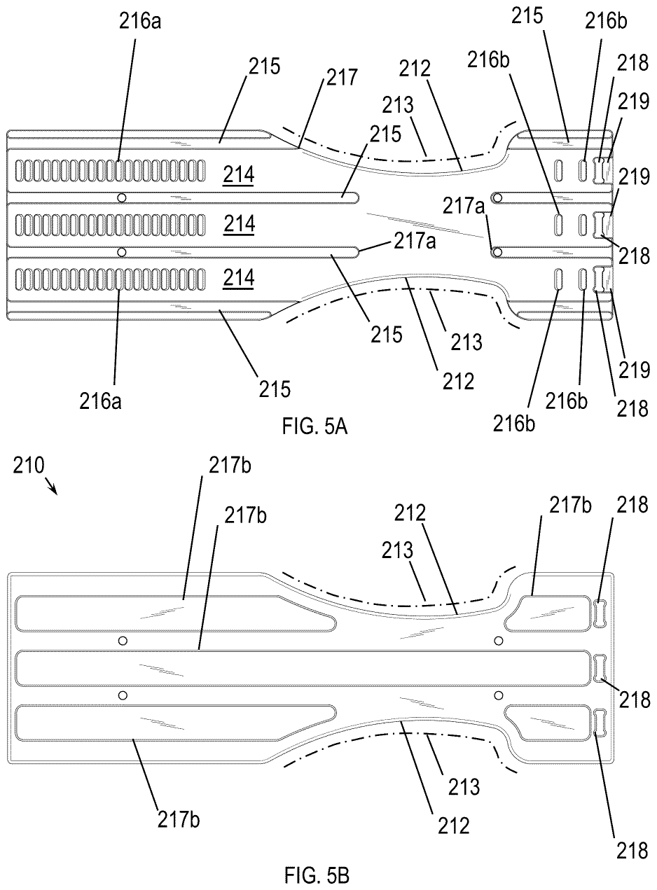

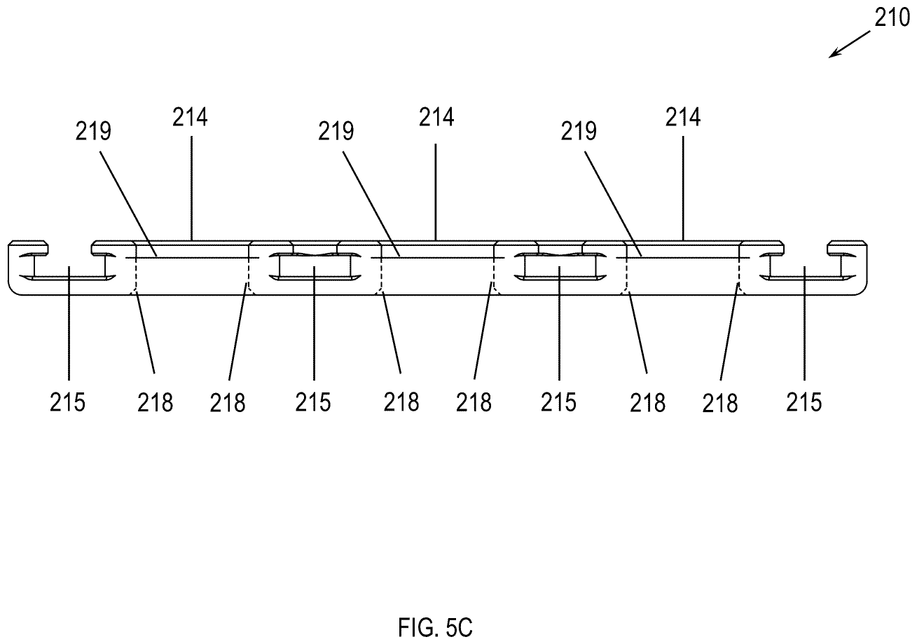

On the posterior side of base plate 210 and in a preferred embodiment, the bracket 220 may couple to a bracket opening 218 wherein the bracket head 221a is configured to reside within a bracket opening recess 219. As perhaps most easily understood from FIG. 4 and FIG. 5C, the bracket head 221a may be flush with or below the upper surface of the base plate 210 so that the posterior support 400 may pass over. In alternative embodiments, any of the previously-described methods of attachment may be used at any of the corresponding attachment locations of the base plate 210.

Referring to FIGS. 4-5C and in an alternative embodiment provided in 14A-14F, the base plate 210 may comprise one or more contours 212 including one or more predetermined shapes 213, a plurality of tracks 214 separated by track slots 215, a plurality of anterior ratchet recesses 216a, and a plurality of posterior ratchet recesses 216b. The base plate 210 may further comprise one or more base plate recesses 217b, such as on the underside of base plate 210 as shown in FIG. 5B for reducing weight thereof. Each track slot 215 may be characterized by a track slot end 217a; the track slots 215 substantially as shown in the various embodiments, which may be useful, inter alia, in setting maximum travel lengths of the anterior and posterior support assemblies 300, 400. Alternatively, the track slots 215 may be continuous from anterior to posterior, or made longer or shorter than the configurations shown herein. The track slots 215 may be cut short by the contour 212, such as is shown in FIG. 5A; as will be elaborated upon further below the anterior and posterior support assemblies 300, 400 may still provide the structural integrity needed to adequately support the patient, when only one track slot 215. The support plate 210 is of sufficient length to extend laterally across the OR table 101, with anterior and posterior ends positioned above the OR table rails 102 to facilitate coupling thereto. Although the embodiments of FIGS. 4-5C and 14A-14F illustrate bracket openings 218 only on the posterior side, the base plate 210 may have that connection type on the anterior side additionally, or alternatively. Furthermore, a single bracket opening 218 may be disposed on a single side of the base plate, as shown in the embodiment of 14A-14F, or the base plate 210 may comprise a plurality of openings 218 arrayed along the caudal/cranial axis.

The base plate 210 may have one or more contours 212 where it intersects with the overlying patient, the contours being characterized by one or more predetermined shapes 213. The contour 212 may be generally purposed to reduce the width of the base plate 210 to fit comfortably between the rib cage and pelvis of the patient, thereby avoiding pressure on skeletal tissue.

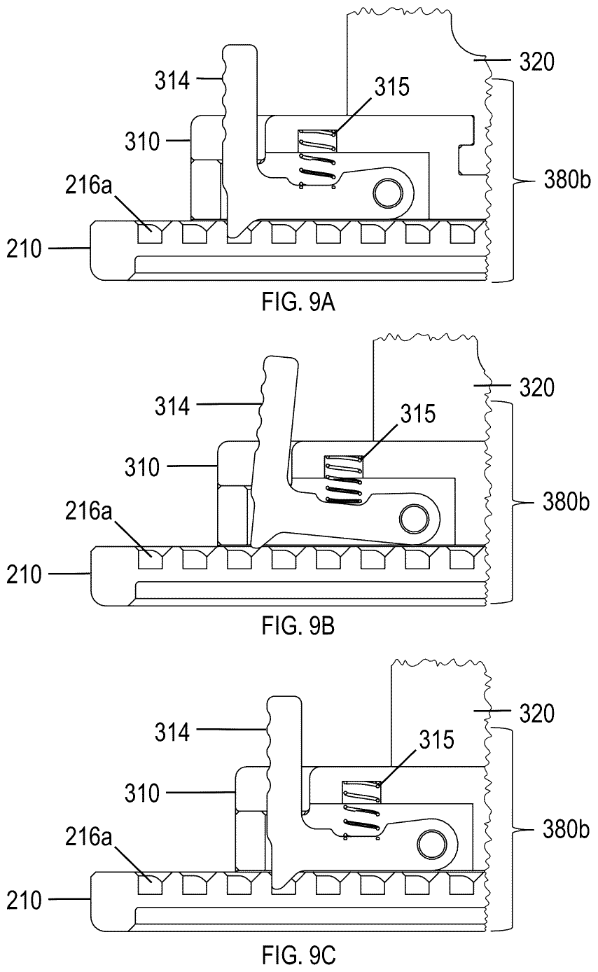

A plurality of anterior ratchet recesses 216a, and posterior ratchet recesses 216b may be configured to receive a latch 314, 414 may be disposed at the anterior and/or posterior ends, respectively. With reference to FIGS. 9A-9C, each ratchet recess may be characterized at least in part by an angled side, where the angle occurs on the side closest to the center of the base plate 210, i.e., toward the center where the patient is positioned. In this way, the anterior ratchet recesses 216a, and posterior ratchet recesses 216b comprise angled sides/edges that face in opposite directions of the other side; this effectively allows each of the anterior and posterior support assemblies 300, 400, to more easily move inwardly, while being configured inhibit movement outwardly.

The plurality of tracks 214 may be of common width so that each of the anterior and posterior support assemblies 300, 400 can be precisely disposed on the base plate 210 in the caudal-cranial direction, so as to advantageously be adjusted by the surgeon according to the size and shape of a particular patient. The plurality of slots 215 may be configured to accept suitably-shaped rails 312, 412a on anterior 300 and posterior 400 support assemblies, respectively. Although the various base plate 210 embodiments are shown and described herein with open anterior/posterior ends, alternative arrangements are contemplated such as closed-end features having diameters larger than the width of either rail types 312, 412a, so as to remove or attach the anterior 300 and posterior 400 support assemblies in an upward or downward direction for a desired method of assembly.

Upon secure coupling of the base plate 210 to the OR table 101, the patient is set thereon and aligned according to the surgeon's preferences. Padding (not shown) made optionally be placed between the patient and the base plate 210. Subsequently the posterior support assembly 400 may be placed on the base plate 210. The base plate 210 (and other components described herein) advantageously provides for multiple positioning options; for example, if the surgeon has a large patient that is difficult to reposition (once on the table), then the surgeon has can modify the location and/or position of a subcomponent—e.g., anterior 300 and posterior 400 support assemblies relative to the base plate 210—rather than having to move and reposition the patient.

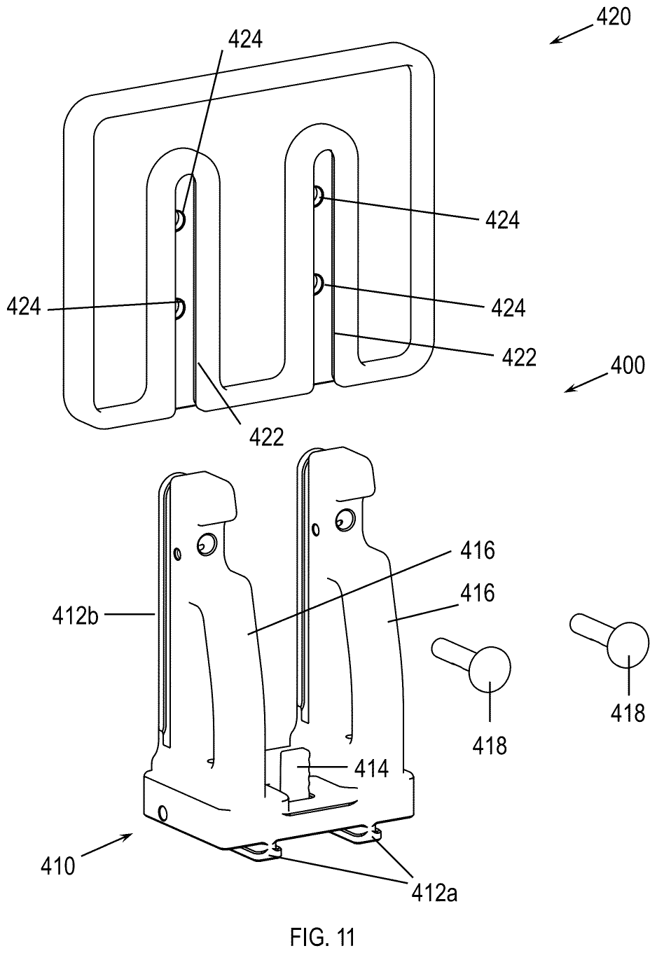

The posterior support subassembly 400 is shown in FIGS. 1-3, 10-12, with an exploded view given in FIG. 11. Posterior support subassembly 400 may comprise a posterior tower 410 operably coupled a lumbar support 420, which in turn may operably couple to a posterior pad 405, where the latter is shown in FIGS. 1-3 and 12. The posterior tower 410 may comprise one or more bottom rails 412a configured to align, couple to, and slide along, a corresponding one or more slots 215 of the base plate 210. Posterior tower 410 may further comprise a latch 414 that couples to the posterior ratchet recesses 216b of the base plate 210. The posterior tower 420 may further comprise a handle 416 that may be centrally formed and angled diagonally, the posterior tower 420 adapted for advancing the posterior support assembly 400 along the base plate 210 toward the patient. The posterior tower 410 may further comprise top rails 412b adapted for coupling to the lumbar support 420, which may comprise lumbar support slots 422 configured to slide onto the top rails 412b. Tower pins 418 in combination with lumbar support pin openings 424 may be used to couple and adjust the vertical position of the lower back support 420.

The posterior support subassembly 400 may be coupled to the support plate 210 by sliding onto one or more tracks 215 and fixedly coupling thereto by virtue of the latch 414 rigidly coupling to a corresponding posterior ratchet recess 216b. At this point in the assembly method, the patient may be positioned on the OR table 101 and aligned with the baseplate plate 210 and posterior support 400, and corresponding pads (not shown) and posterior pad 405.

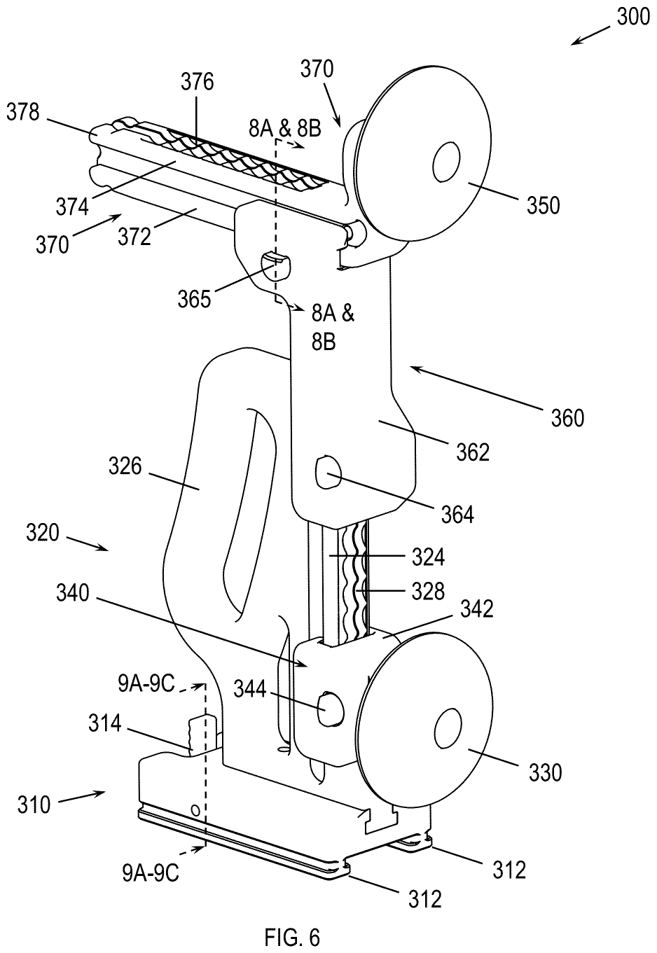

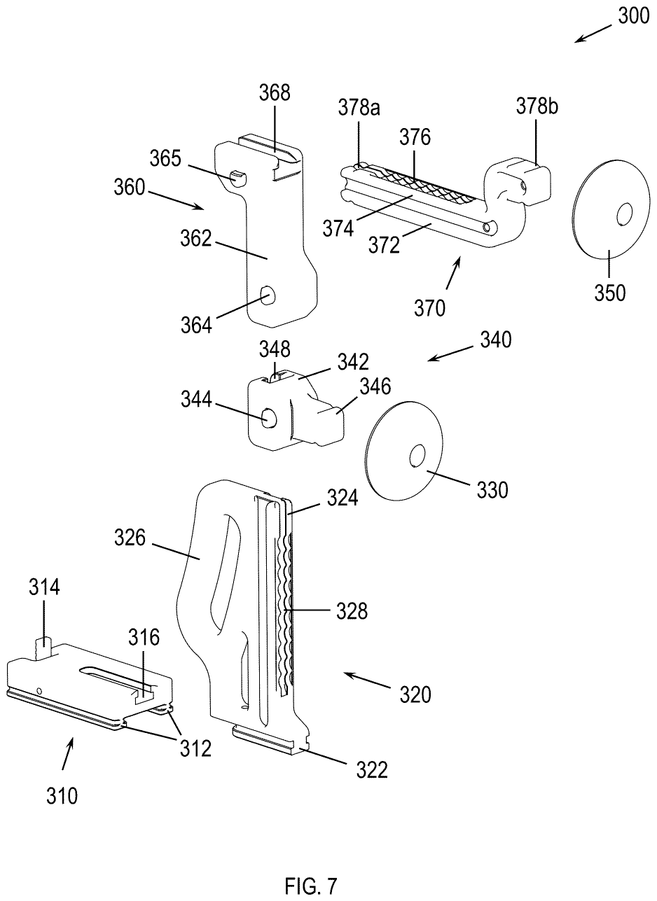

Referring to FIGS. 1-3, 6-7, and 12, the anterior support assembly 300 may be coupled to the support plate 210, by sliding onto one or more tracks 215 and fixedly coupling thereto by a latch 314 and corresponding anterior ratchet recess 216a. The anterior support assembly 300 is shown in detail in FIG. 6 and with an exploded view given in FIG. 7. The anterior support assembly 300 may comprise an anterior tower base 310 operably coupled an anterior tower 320. The anterior support assembly 300 may further comprise upper and lower pad holder supports 360, 340, both operably coupled to the anterior tower 320. The anterior support assembly 300 may further comprise arm 370 operably coupled to upper pad holder support 360. The anterior support assembly 300 may further comprise upper and lower pad holders 350, 330, each respectively fixedly coupled to the arm 370 and a lower pad holder 330 via a snap fit. An upper anterior pad 390a and a lower anterior pad 390b, may each fixedly or rigidly couple to the upper and lower pad holders 350, 330, respectively, via adhesive or the like.

Pads 390a, 390b and/or pad holders 350, 330 may advantageously be dome-shaped, which allow for superior contact with the patient's iliac crest. The iliac crest of a patient is generally curved. The dome shape catches more of the surface—curved surface to curved surface—allows the pad 390a, 390b to find the specific/optimal contact point. The pads 390a, 390b may be disposable, and each of the upper and lower pad holders 330, 350 may have one or two angular degrees of freedom about the attachment area that may provide for further secure coupling to the iliac crests, or other body part, of a patient.

The anterior support assembly 300 may further comprise a latch 314 that couples to the ratchet recesses 216a of the base plate 210. The top of the anterior tower base 310 may comprise a slot 316 for slidably and fixedly coupling to the anterior tower 320, which may comprise a bottom rail 322 configured to slide into the base slot 316. The anterior tower 320 may further comprise a handle 326 for advancing the anterior tower assembly 300 along the support base 210 toward the patient. As the anterior tower assembly 300 advances toward the patient the latching 314 position advances concurrently in combination with the anterior rachet recesses 216a.

The anterior tower 320 may further comprise a side rail 324 configured to receive the lower domed pad holder support 340, which may comprise a vertical slider 342 with a vertical slider slot 348 disposed therein. An anterior tower pin rack 328 may be disposed on the anterior tower 320 and serve to aid in positioning of the lower vertical slider 342 in cooperation with a lower vertical slider push pin 344. The lower domed pad holder support 340 may further comprise a lower domed pad holder adapter 346 configured to couple to the lower domed pad holder 348, to create a snap fit or “clip-on” fit.

The anterior tower side rail 324 may also be configured to slidably couple to an upper domed pad holder support subassembly 360 which also may be fixed to the anterior tower 320 by the interaction of a vertical push pin 364 disposed on a vertical slider 362 and the anterior tower pin rack 328. The upper vertical slider 362 may be configured to slidably couple to the arm 370 with bottom 372 and top 374 rails. The arm 370 may be fixedly coupled to the upper vertical slider 362 by the interaction of a horizontal push pin 365 and arm pin racks 376, which may be disposed on bottom (not shown) and top (shown) surfaces. The arm 370 may further comprise one or more upper domed pad holder adapters 378a, 378b disposed on either or both ends and configured to receive the upper domed pad holder 350. Advantageously, the one or more upper domed pad holder adapters 378a, 378b, provide for three distinct coupling orientations of the upper pad holder 350 to the patient: (i) 378b in an upright position, as illustrated e.g., in FIG. 6-7, (ii) in a downward position, wherein the arm 370 is rotated about the long (horizontal) axis by 180 degrees, such that the adapter 378b lies lower than the rail 374, and (iii) in a reverse direction, wherein the adapter 378a couples to upper pad holder 350 such that the adapter 378a faces the posterior side and the adapter 378b faces the anterior side of the OR table 101.

When assembling the surgical patient positioner 100, according to the apparatus, system, and/or method of the present invention, the anterior support assembly 300 may slidably couple to the base plate 210 starting proximate the anterior side, and slidably moving to the posterior side. Similarly, the posterior support assembly 400 may slidably couple to the base plate 210, starting proximate the posterior and slidably moving to the anterior side, thereby securing the patient between the two assemblies. The base plate 210 may comprise one or two contoured sides 212 configured below the patient, the contour shape having a predetermined profile or shape 213, as shown in FIGS. 5A and 5B. The predetermined shape 213 may be ergonomic in design, and generally suited to relieve or reduce the pressure exerted on the patient by the base plate 210 and to minimize the hard surface with the patient's non-operative side. Alternatively, the predetermined shape 213 may take a different shape from that shown in FIG. 5A or 5B, suitable for the stated purpose of reducing damage to the body tissue of the patient and decreasing post-surgical discomfort.

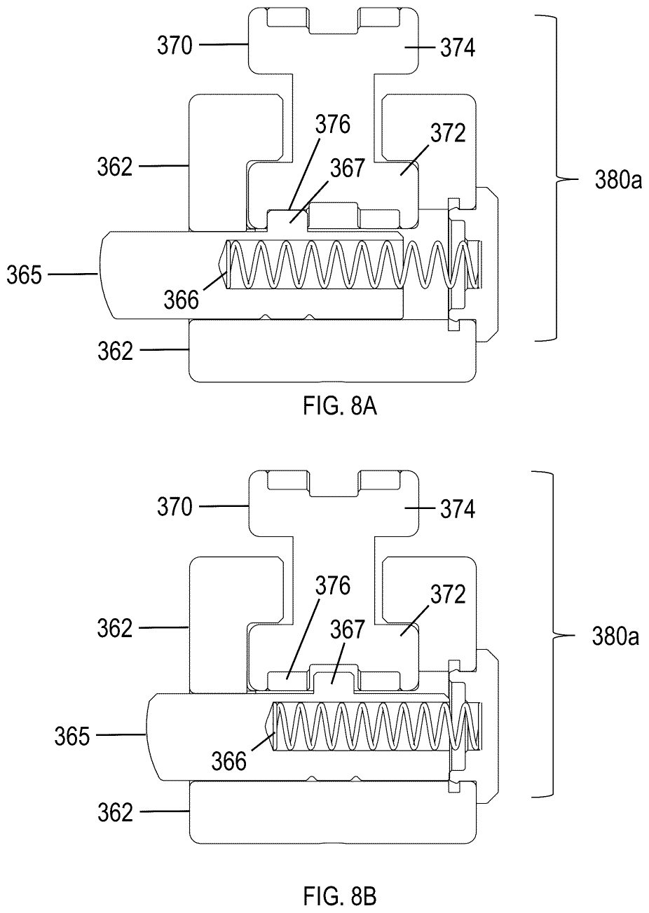

Referring to FIGS. 8A & 8B, a first category of fastener assembly 380a is disclosed, which is shown in the context of the location provided in FIG. 6 according to the cross section at horizontal push pin 365. First fastener assembly provides superior holding characteristics, and may be deployed in other operable locations of surgical patient positioner 100, namely at vertical push pin 364, and/or push pin 344. Horizontal push pin 365 may comprise biasing element 366 coupled to the push pin key 367, which may operably couple and/or interact with arm pin rack 376 of arm 370. Biasing element 366 may be biased open or outward at resting state, so that the operator's action advances the push pin 365 inwardly, and upon sufficient movement thereof, the push pin key 367 clears the arm pin rack 376 to allow horizontal displacement and/or advancement of the arm 370. This arrangement of parts, according to the present invention, reduces or eliminate the likelihood of unintended movement, once the patient is put in the desired position, which represents a benefit over the prior art which is achieved at least in part by the pressing a physical actuator, or other positive action, that results in disengagement of an associated pawl or ratcheting mechanism.

Referring to FIGS. 9A-9C, a second category of fastener assembly 380b is disclosed, which is shown in the context of the location provided in FIG. 6 according to the cross section at latch 314 of tower base 310. Second fastener assembly provides superior holding characteristics, and may be deployed in other operable locations of surgical patient positioner 100, namely latch 414. The tower base 310 may comprise biasing element 315 coupled to the latch 314, wherein the biasing element biases the latch 314 downward or in an engaged position with anterior ratchet recess 216b. With this second category of fastener assembly 380b, the operator may exert a sideways force, from left to right (anterior to posterior) as shown in the progression of FIGS. 9A-9C to advance the tower base 310 and engage with, or further tighten against, the patient. The angled right-hand edge of each anterior ratchet recess 216b allows the tower base 310 to advance accordingly (See FIG. 9B in particular). To release, the operator depresses the latch 314 so that it releases from the series of anterior ratchet recesses 216b, and slidably advances from right to left (posterior to anterior direction). This arrangement of parts, according to the present invention, reduces or eliminate the likelihood of unintended movement, once the patient is put in the desired position, which represents a benefit over the prior art which is achieved at least in part by the pressing a physical actuator, or other positive action, that results in disengagement of an associated pawl or ratcheting mechanism.

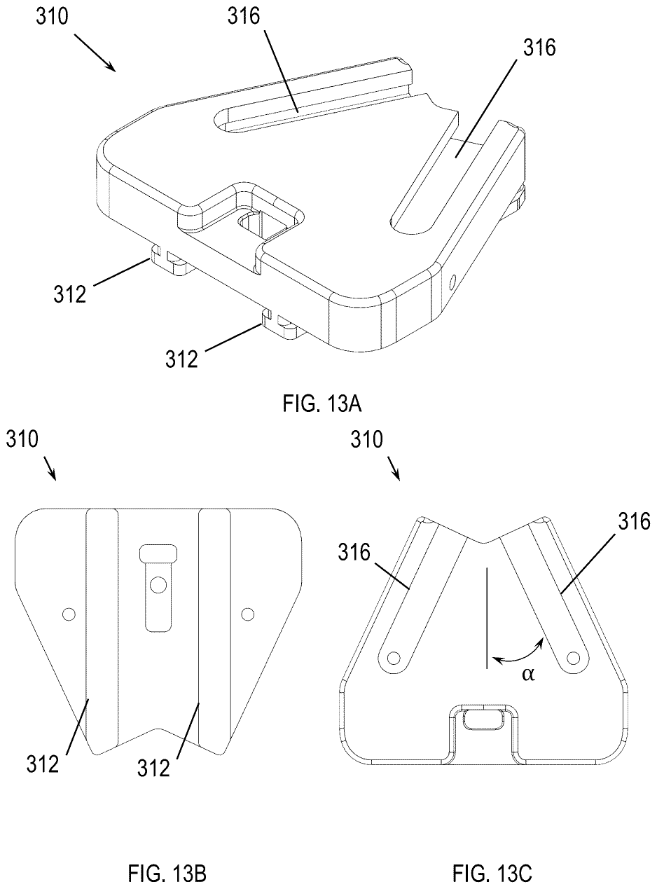

In an alternative embodiment of the present invention, referring to FIGS. 13A-13C, an angled tower base 310 is disclosed. The angled tower base 310 may comprise one or more rails 312 and one or more angled slots 316. Angled slots 316 may vary in orientation with respect to the rail 312 direction by an angle α as shown in FIG. 13C. This alternative angled tower base 310 embodiment may be desirable in place of the aforementioned tower base 310 embodiment(s), to provide variations on holding force direction, and/or location of the anterior support assembly 300, as desired by the surgeon.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A surgical patient positioner comprising:
a base plate comprising;
a plurality of anterior and posterior tracks configured to slidably couple to anterior and posterior supports, respectively, the anterior and posterior tracks having one or more ratchet recesses disposed therein;
one or more openings configured to receive a bracket,
a contoured portion adapted to fit between the pelvis and rib cage of the patient;
one or more brackets configured to couple to the support plate at one end and a rail of an operating room table at the other end;
one or more clamps adapted to secure the bracket to a rail of an operating room table
an anterior support assembly comprising:
a tower base comprising:
one or more bottom rails configured to slidably couple to the plurality of anterior support plate tracks;
an anterior latch adapted to couple to the one or more ratchet recesses;
a base slot;
an anterior tower comprising:
a tower bottom rail adapted to slidably couple to the base slot;
a handle;
a tower side rail;
a tower pin rack;
a tower top slot;
a lower domed pad holder;
a lower domed pad holder support comprising:
a lower vertical slider configured to slidably couple to the tower side rail comprising;
a lower vertical slider push pin adapted to couple to the tower pin rack thereby fixing the lower vertical slider position;
a lower vertical slider adapter configured to couple to the lower domed pad holder;
an upper domed pad holder;
an upper domed pad holder support comprising:
an upper vertical slider configured to slidably couple to the tower side rail comprising;
an upper vertical slider vertical push pin adapted to couple to the tower pin rack thereby fixing the upper vertical slider position;
an upper vertical slider horizontal push pin;
an arm comprising:
arm bottom rail and arm top rail adapted to slidably couple to the tower top slot;
an arm pin rack adapted to couple to the upper vertical slider horizontal push pin thereby fixing the arm's horizontal position;
one or more domed pad holder adapters configured to couple to the upper domed pad holder;
a posterior support comprising:
a posterior tower comprising:
one or more bottom rails configured to slidably couple to the plurality of posterior support plate tracks;
a posterior latch adapted to couple to the one or more ratchet recesses;
one or more side rails;
one or more handles;
a lower back support plate comprising:
one or more slots configured to slidably couple to the one or more side rails;
one or more pin openings; and
one or more pins adapted to couple to the one or more pin openings thereby fixing the vertical position of the lower back support plate.

2. The surgical patient positioner of claim 1 wherein one or more extension bars may be disposed between the support plate and bracket.

3. The surgical patient positioner of claim 1 wherein the arm comprises an S-bend and may be coupled to the tower top slot by the arm bottom rail or arm top rail and may be inserted therein in a forward or reverse orientation.
